(19) United States
(12) Patent Application Publication
(10) Pub. No.: US 2011/0080014 A1
(43) Pub. Date: Apr. 7, 2011

(54) GARDEN TOOL DESIGNED FOR HARD PACK SOIL

(76) Inventors: Gregory K. Baker, Fuquay-Varina, NC (US); Carl R. Baker, Herlingen, TX (US)

(21) Appl. No.: 12/833,228

(22) Filed: Jul. 9, 2010

Related U.S. Application Data
(60) Provisional application No. 61/248,487, filed on Oct. 4, 2009.

(51) Int. Cl. A01B 1/20; A01B 1/02; A01B 1/04; A01G 3/08

(52) U.S. Cl. 294/51; 294/55

(57) ABSTRACT

The present invention relates to a novel garden spade wherein the scoop portion has straight sides. In addition, the proximal end of the scoop has a hammer plate uninterrupted by the neck which neck is attached to the scoop of the spade distal to the hammer plate. The neck and handle attached to the neck are angled such that the hammer plate can be struck with the greatest amount of clearance and best angle of attack for hitting a spade compared to previous spades which are not designed to successfully be hit without damage to either the spade, the user or both.

This application claims priority of U.S. provisional application 61/248,487 filed on Oct. 4, 2009 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a garden tool. In particular, it relates to a garden tool that is designed to work well in hardened soil conditions and provides the ability to plant, prune and harvest using the tool.

2. Description of Related Art

The garden tools, such as small hand spades, are commonly used for digging and planting. Spades are a type of tool used for digging, smoothing, or otherwise moving around small amounts of viscous or particulate material. In gardening, a garden spade is a tool with a scoop-shaped metal blade having a pointed distal end, a handle and a neck portion connecting the handle to the very back end (proximal end) of the scoop. It is used for breaking up earth, digging small holes, especially for planting and weeding, mixing in fertilizer or other additives, and transferring plants to pots.

The garden spade is frequently constructed with two small shoulders that are formed on either side of the neck of the spade. In hard or difficult to penetrate soil conditions current spades are difficult or impossible to utilize due to the design which only allows the user to utilize hand pressure on the handle while digging, planting or cultivating the soil. Users that would attempt to strike the shoulders of the spade or otherwise forcefully attempt to utilize the shoulders of the spade will likely cause the spade to twist, bend or break since the shoulders of current spades are not designed to be utilized in this manner. Further, attempting to strike the shoulders of a spade with a mallet or hammer will likely result in the user inadvertently striking the neck or handle resulting in the bending, breaking or permanent destruction to the shoulders of the spade and possible injury to the user. Common spade designs also have a pointed tip and tapered sides which form a triangular shape which is also unsuitable for hard packed soil conditions and cutting through soft impediments such as existing root systems. It is not uncommon for users to bend or break off the pointed tip of the spade while attempting to utilize in difficult soil conditions, such as hard packed clay. In general, the design of the current garden spades are just not suitable for digging through hard pack soils, clay or soft impediments such as existing root systems or the like which require a great deal of force to penetrate.

### BRIEF SUMMARY OF THE INVENTION

The present invention relates to a novel design for a garden spade that is useful and overcomes the prior problems with using a garden spade in thick, dense, hard packed soils, soft impediments like roots, or the like. Specifically, by use of a straight digging edge with parallel sides, a hammer plate and an offset neck, one can dig or hammer into tough soils with ease when compared to previous spades without risking damage to the user's hand, the handle, neck, shoulders, or blade of the spade.

In one embodiment, the present invention relates to a garden spade comprising:
a) a scoop blade portion having a straight edge distal end, essentially parallel side edges and an hammer plate proximal end;
b) a neck portion attached to the scoop portion in spaced relationship to the proximal end of the blade; and
c) a handle portion mounted to the neck portion and angled away from the blade portion.

### BRIEF DESCRIPTION OF THE DRAWINGS

FIG. 1 is a top view of an embodiment of the present invention.

FIG. 2 is a side view of an embodiment of the present invention.

FIG. 3 is a head-on view of an embodiment of the present invention.

FIG. 4 is a perspective view showing the measurement marking embodiment.

FIG. 5 is a view of an embodiment in use.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “scoop blade portion” refers to the blade of the spade having a lengthwise curved configuration. A curve is frequently defined as a portion of the circumference of a circle having a particular radius, but any method of making a curve may be utilized. The curve is designed to allow the user to scoop up soil or other materials with the spade of the present invention. The curve of the scoop is within the skill of one skilled in the art in view of this disclosure. In one embodiment the spade has a curve based on a radius of 2.913 inches. The thickness of the blade can be either uniform or tapered from the proximal to the distal end and in one embodiment is about ¼ inch at the proximal end tapering down to about ⅛ inch at the distal end but any thickness for a spade is within the scope of the invention.

The length of the blade can be from about 4 to about 12 inches in length but in one embodiment it is about 9 inches in length. Likewise, the width will be narrower than a standard garden spade and would be about 1.5 inches to about 2.0 inches in length with one embodiment being about 1.75 inches. The blade can be made from any material suitable for utilization in hard soils. In general, metals would be utilized and hardened steel, stainless steel, aluminum and the like are typical materials. The blade made of metal can be manufactured by any convenient means for making a spade blade such as casting, forging or the like.

As used herein the “distal edge” of the blade portion refers to the end of the blade furthest from the handle. In a standard garden spade the distal end is tapered to a point, however, in the present invention the distal in is a “straight edge” cut perpendicular across the length of the blade portion. The distal edge can be just cut across metal or in one embodiment can be sharpened as desired to form a blade edge. In one embodiment of the present invention, the distal edge can further comprise a root tooth or a sharpened v-shaped groove that can comprise in one embodiment about 30 to 60 percent of the distal edge. A root tooth is sufficiently sharp to cut or penetrate soft soil impediments such as roots and the like. In one embodiment it is approximately 50% of the width of the distal edge. A root tooth can be used to cut through soft impediments, hard soil or the like while digging or hammering on the hammer plate with the present invention garden spade.

The sides of the length of the blade, unlike a regular garden spade, are essentially parallel instead of the tapered configuration of the standard garden spade. The parallel sides further aid in penetration into the soil as opposed to a tapered design which gets progressively more difficult the wider the blade becomes.

The end of the blade portion opposite the distal end is the proximal end. The proximal end is configured into a hammer plate or, in other words, a thickened end or thick piece end perpendicular to the length of the blade and having a flat portion for hammering the blade portion into the ground. The thickness of the hammer plate depends on the material utilized and the particular spade, but is from about a quarter inch to about a half inch or so in thickness and tapers away from the proximal end. In one embodiment, the hammer plate is about 0.375 inch in thickness. In the construction of the hammer plate, it is wide enough to easily strike with a hammer wherein the blade is thick enough to both attach the hammer plate and support being struck repeatedly. Obviously the plate is thicker than the normal shoulder appearing on spades. The blade can be as thick as the hammer plate, thinner, or thinner and tapered, for example, tapered from about a quarter inch down to about an eighth of an inch in thickness while the hammer plate itself is about half an inch in width. The hammer plate does not have any interruptions and one can hammer directly in the center of the hammer plate without obstruction since the neck is not mounted to the distal end as are standard garden spades having two shoulders with the neck in the middle. The hammer plate can be added on separately, e.g. by welding or the like, can be forged or cast into the end of the blade portion using standard fabrication or forging techniques.

As used herein, the “neck portion” refers to the connection piece on the spade of the present invention between the handle and blade. One end of the neck portion is attached to the scoop portion on the top, in spaced relationship to the proximal end of the blade (just below the hammer plate). By “spaced relationship” is meant that it is mounted away from the end, for example, about a half inch to about an inch and a half from the proximal end of the blade. In one embodiment, the neck is metal and welded, or the like, to the blade portion. When attaching, it is positioned along a centerline of the curve of the blade such that equal portions of the blade are on either side of the neck. This allows the blade to be balanced in relationship to the neck and handle. The portion of the neck which enters or is attached to the handle is the tang of the neck. The tang can enter into a portion of the handle and in one embodiment the tang extends through the entire length of the handle (a full tang).

The neck portion is mounted on the scoop side of the blade (the part that holds the soil) at an angle of about 80 to 90 degrees relative to the plane of the spade. In other words it is ether perpendicular to the plane of the spade or about 10 degrees forward or back from perpendicular and not side to side. For example, by noting the centerline of the spade, the angle can be measured from this line. In one embodiment, the angle of the neck portion is in a proximal direction, and in one embodiment, it is about 83 degrees leaning in a proximal direction. The angles for the neck described herein allow for the greatest clearance and angle of attack hitting the hammer plate with a hammer when compared with the standard spade.

The handle portion of the spade is a device for grasping the spade with a single hand. It can be round, have finger grips or virtually any shape that allows grasping by one hand. It can be made of wood, plastic, metal or the like and handles in general are within the skill of the art. In one embodiment it has a full tang. The handle is mounted to the end of the neck opposite where the neck is attached to the blade portion. It is mounted such that it is angled away from the blade portion, i.e. has an angle greater than 0 in relationship to the plane of the blade as described above for the neck portion. In one embodiment, it is angled at about 20 to 40 degrees relative to the plane of the blade and in another embodiment, it is positioned at an angle of about 30 degrees relative to the plane of the blade (or another way of saying is it is 60 degrees from a perpendicular line off of the plane of the blade).

Other features can also be included in the present invention. In one embodiment of features, there are one or more cutting hooks in at least one of the parallel side edges. These hooks do not extend past the edge of the side and thus do not interfere with the insertion of the scoop into dirt. These cutting hooks can be used as a pruning device and will thus be sharpened to make them effective to cut and prune small plants and branches. In one embodiment there is one hook on either side of the blade portion.

In another embodiment of the present invention there are measuring marks, e.g. inch lines, on the blade portion to aid in the planting of seedlings, plants and the like. Other amenities, for example, hanging hooks, and the like could also be included in the present invention.

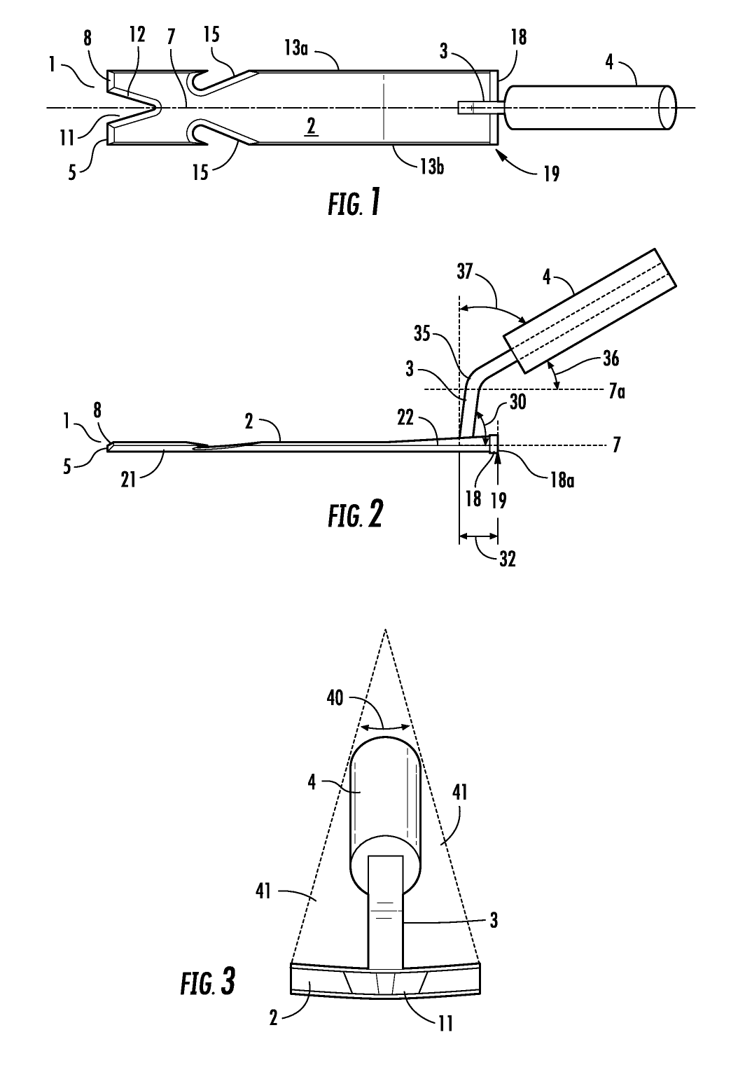

Now referring to the drawings, FIG. 1 depicts a top view of an embodiment of the present invention. Spade 1 consists of blade portion 2, neck 3 and handle 4. The blade 2 has distal end 5 which is cut essentially perpendicular to the centerline 7 of the blade 2. The distal end 5 is a straight edge and in this embodiment has blade taper 8 (a blade taper is a thinking of the thickness of the metal and sharpened to a cutting edge). Also positioned with its apex along the centerline 7 is V-notch 11 for cutting roots and the like. V-notch 11 also has blade taper 12. The long sides of the blade 2 are indicated as sides 13a and 13b and are essentially parallel to one another.

Positioned along the length of sides 13a and 13b are pruning hooks 15 which are sharpened with a blade taper and do not extend past the edges of the two long sides 13a and 13b. The hammer plate 18 at the proximal end of the blade is shown from the top and has edge 19, which is essentially perpendicular to centerline 7 and has nothing mounted to it to interfere with the smooth surface of edge 19.

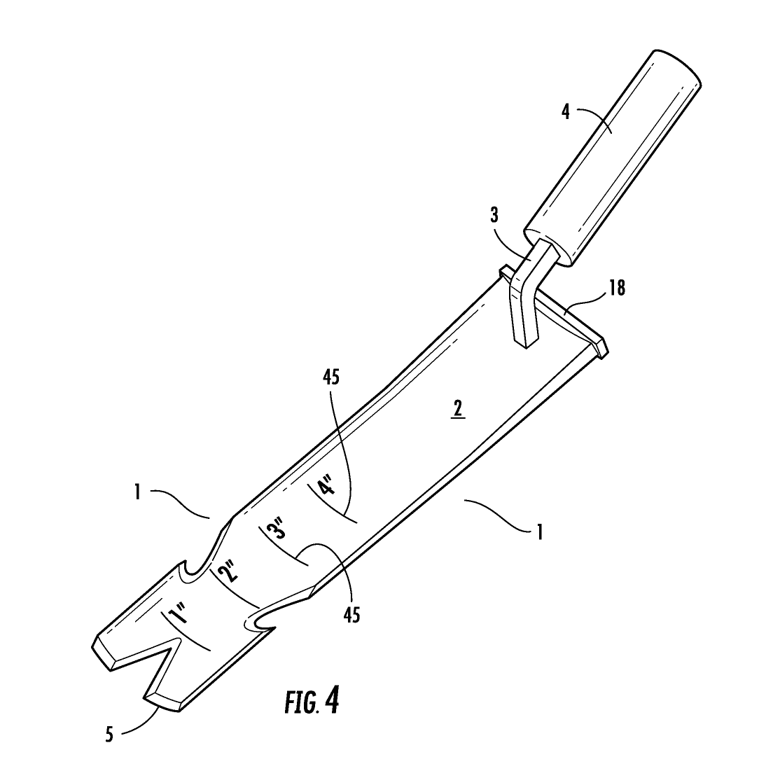

FIG. 2 depicts a side view of an embodiment of the present invention. In this view, one can see that the blade 2 has a thickness toward the distal end of 21, while toward the proximal end, it has thickening portion 22 which tapers from the distal thickness 21. In this view, one can see the hammer plate surface 18a of hammer plate 18 including the straight edge 19.

The neck 3 in this view is angled at angle 30 relative to centerline 7. In this embodiment, it is an angle of about 83 degrees from centerline 7 that is leaning 7 degrees proximal from a perpendicular to the centerline. The neck 3 is also in spaced relationship to the proximal end hammer plate 18 by distance 32. Distance 32 keeps the neck 3 close to but away from the hammer plate 18, in this embodiment about an inch and in all cases no further than the midpoint between the distal and proximal ends of the scoop 2.

The handle 4 is attached to neck 3 by insertion of the neck into the handle. Depicted in this figure is a full tang neck where neck 3 is inserted into handle 4 the full length of the handle 4. Clearly, a partial tang or other attachment means for neck and handle could be utilized in keeping with the teaching of the present invention. The neck is bent at joint 35. A joint or bend in a metal piece is utilized in this embodiment but any connection means is sufficient. The handle attached to the neck is at an angle measured relative to centerline 7 or for convenience parallel line 7a. The angle 36 is relative between the centerline and the center axis of the handle, and in this embodiment is about thirty percent from the centerline. A perpendicular line 37, which is perpendicular to centerline 7, is also shown for reference and the handle is 60 degrees proximal from this line in this embodiment.

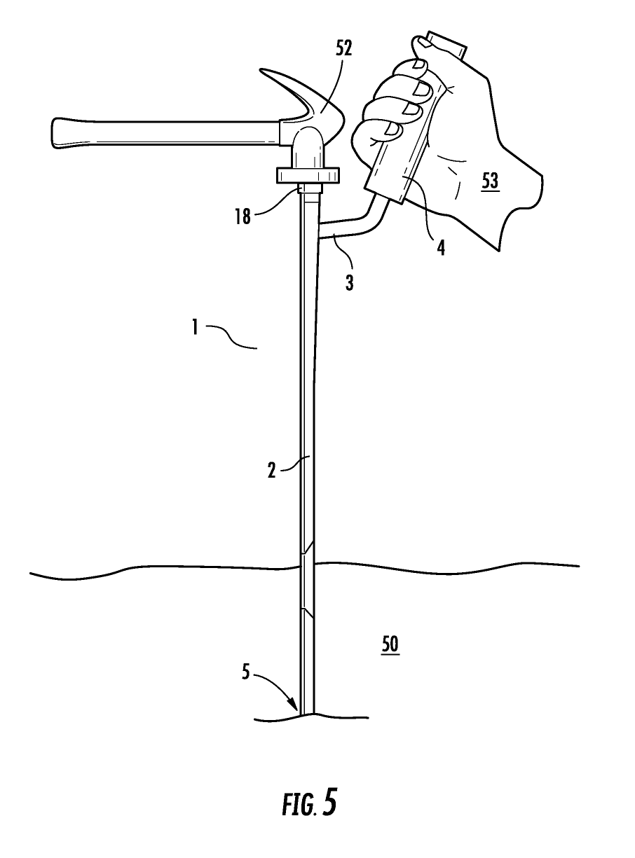

FIG. 3 shows a head on view of the spade 1 in order to show the curvature of the blade portion 2, as well as another view of the blade thickness. The curve can be defined by the angle 40 between two radii 41. FIG. 4 shows a perspective view of the present invention spade 1. This view is presented to further show the construction of the spade and the additional embodiment of measurement markings 45.

FIG. 5 depicts a side view of the spade of the present invention in use in digging straight into soil 50. The spade 1 is placed perpendicular to soil 50 with the distal end into the ground 50. In this view, the spade 1 is being held by hand 53 while being hit by hammer 52. One can clearly see that because of the unique configuration of the handle and neck portion, that the hammerplate 18 can be hit by hammer 52 easily without hitting the neck 3, the handle 4, or the hand 53, since all three are clear of the movement of the hammer in hitting the hammer plate 18. Because of the alignment and unique shape of the spade, the spade can be repeatedly hit on the hammer plate and easily go straight into soil 50, and represents an improvement over prior spades.

The examples above are not necessarily considered to be limiting unless the applicant wishes to claim specific embodiments of the invention. Otherwise, nothing herein is intended to be limited by the claims which follow. Applicant reserves the right to narrow the claims consistant with the invention as necessary.

What is claimed is:

1. A garden spade comprising:
a) a scoop blade portion having a straight edge distal end, essentially parallel side edges and a hammer plate proximal end;
b) a neck portion attached to the scoop portion in spaced relationship to the proximal end of the blade; and
c) a handle portion mounted to the neck portion and angled away from the blade portion.

2. A garden spade according to claim 1 wherein there is a v-notch in the straight distal end.

3. A garden spade according to claim 1 wherein there are one or more cutting hooks in at least one of the parallel side edges.

4. A garden spade according to claim 1 wherein the neck portion is mounted to the blade at an angle of about 80 to 90 degrees relative to the plane of the blade.

5. A garden spade according to claim 4 wherein the neck portion is mounted at an angle of about 83 degrees relative to the plane of the blade.

6. A garden spade according to claim 1 wherein the handle portion is mounted to the neck portion at an angle of about 20 to 40 degrees relative to the plane of the blade.

7. A garden spade according to claim 6 wherein the handle portion is mounted to the neck portion at an angle of about 30 degrees relative to the plane of the blade.

8. A garden spade according to claim 1 wherein the blade has measurement markings on the blade.

9. A garden spade according to claim 1 wherein the blade is made from hardened steel or stainless steel.

10. A garden spade according to claim 1 wherein the blade is about 1.5 to 2 inches in width.

11. A garden spade according to claim 1 wherein the blade is about 4 to 12 inches in length.

12. A garden spade according to claim 1 wherein the neck is a full tang within the handle.
